(19) United States
(12) Patent Application Publication
(10) Pub. No.: US 2009/0217340 A1
(43) Pub. Date: Aug. 27, 2009

(54) METHODS AND SYSTEMS FOR CLINICAL CONTEXT MANAGEMENT VIA CONTEXT INJECTION INTO COMPONENTS AND DATA

(75) Inventors: Joseph Sitomer, Kirkland, WA (US); Vijayanand Tirumalai, Draper, UT (US); William Murray Stoval, Draper, UT (US); Herman Bailey Post, Salt Lake City, UT (US); Alan F. James, Salt Lake City, UT (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 12/035,269

(22) Filed: Feb. 21, 2008

(51) Int. Cl. G06F 21/00; G06F 17/00

(52) U.S. Cl. 726/1; 726/27

(57) ABSTRACT

Certain embodiments present a system for managing access to patient data in a clinical information system that uses software applications, and a context manager that facilitates the sharing of context among the applications. The system has one access point, or a computer workstation terminal, allowing for user interaction with said at least two software applications. A centralized database stores information relating to patient data and user attempts to access patient data by the software applications. A first context identification module assigns a context label to each access attempt, and a second context identification module assigns a context label to data gathered by the software applications. An auditor regulates relationships between the software applications manager and provides a user interface enabling access to the centralized database. The auditor identifies impermissible application tasks based on rules and identification labels, and prevents access to impermissible application tasks through the user interface.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Certain embodiments of the present technology relate to context management in a clinical information system. More particularly, certain embodiments relate to methods and systems for integrating context between application components using a hierarchical context model.

Context management provides a framework that operates in conjunction with context-enabled software applications to streamline, simplify and coordinate the process of accessing stored data and records responsive to actions by a user of the system. If a common attribute is shared between data records to be accessed by applications or components of applications within the system, this common attribute, such as log-in information for example, may need to be repetitively entered into the respective interfaces presented by each application. Since the applications may not come from a single vendor, each application or application component may further have a different interface or may require a different entry by an application user before the application retrieves and presents the data record which the user has asked for.

Many fields of endeavor can benefit from the use of context management. A brief list includes healthcare, sales, government administration, education, and insurance, for example. An attempt has been made in certain industries, for example in the health care industry, to formulate a standard for exchange of context-related information between context-enabled applications.

In a clinical healthcare system, one application might be directed to patient billing records, and is primarily used by administrators and accountants, while another application that may run on the same platform could present medical image data, for use by physicians and medical professionals. In such cases, a user, for example a patient's primary caregiver, may wish to first view medical record data or medical images for a particular patient, and in the same session view that patient's billing account information or insurance information. Without context management, the primary caregiver would be required to enter data to identify him or herself in order to log in to the various databases containing the desired information, as well as provide patient identifying information so that the particular patient's records may be pulled up in the query. If several such applications are open, it becomes time-consuming and cumbersome to enter the required information and login data into each application's individual user interface. Furthermore, mistakes in typing account numbers or social security numbers, etc., can occur more often when repetitive entry is required. Mistakes with entering or editing patient data can lead to dangerous consequences in the treatment of a patient.

In order to assist users who are using context-enabled applications, a “context manager” which supports context-enabled applications, is used to pass context data between one application and another. “Context data” is information indicative of a condition or identity associated with users, applications, stored records, or any other information that facilitates or enables performance of inter-application or inter-platform functionality in a context management environment. The context data may contain data useful for accessing data relating to or identifying an attribute of a user, machine, application, customer, or patient.

By carrying out certain actions, referred to as “context gestures,” a user using a context-managed environment causes context data to be generated and transmitted through the context manager through user requests or commands. The context gestures may take any of numerous forms, but generally are responsive to a need by the user to move between applications or modules executing in a data processing system. The context in which the gestures are carried out may be transmitted from a first application to a second application to simplify the work of the user, as described above, so that the second applications “knows” what context the user is working in at the time the user shifts from using the first to using the second application. This looking-ahead functionality is a shortcut that shifts some of the burden of cross-application work from the user to the context manager.

Context management in clinical information systems the can provide a useful and flexible tool for presenting a variety of applications of complicated systems to multiple different users, each of different responsibilities. For example, within a given system, a doctor may wish to access a patient's record from a home office to order medication for the patient. However, the hospital may have a rule that a user must be within a specific department when ordering medications for a patient in that department. The doctor may, remotely from the home office, declare to be within the department by providing an authentication such as a user identification or login to grant the doctor access to order medications remotely. Additionally, context management allows a single user to manipulate patient data with multiple applications at one time. For example, in diagnosing a patient primary caregiver may access a patient's treatment history with one application, and copy information pertaining to allergies, prior prescriptions and/or treatments into an application diagnosing the patient's present encounter. Context management simplifies use of multiple applications, such that they exist as a composition of individual, reusable fragments or components running concurrently within a framework integrating the presentation of each application for the specific needs of particular users, data content or workflow.

Though context management provides a simplified means for operating multiple applications, balancing the needs and access of particular users while maintaining safety, privacy and control privileges creates significant challenges, particularly in the medical field. Because application components operate independently within the context management framework, it is necessary to provide tight management of the context to prevent complications or mistakes from occurring. With multiple applications sharing access to the same entries of patient data, it is possible to make modifications to patient data that should not otherwise be made. Severe risks may occur if a user improperly charts patient data, or if the system improperly administers treatment, therapies, or medications due to a system or user error. For example, a user without authority to provide patient medications may accidentally add or delete vital patient information pertaining to medications through use of an application to which the user does have authority to operate, if the context of the system is not managed appropriately.

Additionally, the operation of multiple software applications within a common interface can add to disorganization, slow down user's operations and may draw valuable system memory and resources, particularly where the applications do not operate in common environments. For example, a user centric component such as a message inbox tool does not aid a user operating in a patient medication application, though it may get in the way of the user's objectives and slow down the processor at the user workstation. Thus there exists a need to provide a context management system that coordinates applications and user work tasks by providing rules and establishing a framework of access and usability by coordinating context of the system.

### BRIEF SUMMARY OF THE INVENTION

Certain embodiments present a system for managing access to patient data in a clinical information system that uses software applications, and a context manager that facilitates the sharing of context among the applications. The system has one access point, or a computer workstation terminal, allowing for user interaction with said at least two software applications. A centralized database stores information relating to patient data and user attempts to access patient data by the software applications. A first context identification module assigns a context label to each access attempt, and a second context identification module assigns a context label to data gathered by the software applications. An auditor regulates relationships between the software applications manager and provides a user interface enabling access to the centralized database. In certain embodiments, the auditor identifies impermissible application tasks based upon the rules and said identification labels, and prevents access to said impermissible application tasks through said user interface.

Certain embodiments present a method of managing context shared among multiple software applications within a clinical information system that allows a user to access and modify patient data. The method provides a centralized database for storing and maintaining data and information relating to patient and clinical records. The method further provides a user interface allowing a user to request access to software applications to provide access to patient data and to allow for the modification and addition of patient data via user work tasks. The method audits user access to the software applications and patient data by establishing a multidimensional hierarchical context model for classifying said user work tasks, establishing system rules identifying allowable and impermissible interaction relationships between the applications, patient data and said user work tasks, acquiring an access context label for each user request for information within the system by applying the multidimensional hierarchical context model to each request, acquiring a data context label for each data element accessed or generated by the software applications to each data element, and permitting or denying execution of user work tasks and access to the software applications and patient data through the user interface based on the established system rules and access or data context labels.

Certain embodiments provide a computer readable medium encoded with instructions for execution in a computer system comprising software applications, a context manager that facilitates sharing of context among the software applications, a centralized database accessible to said context manager, an auditor providing an interface enabling a user to extract information from said centralized database. The instructions, when executed on a computer system, establish a context hierarchy, establish application relationship rules to govern interaction of the applications with patient data, user access requests, and user commands. The instructions also assign a context label to each user access attempt based on said contextual hierarchy. The instructions further audit each user task by applying the relationship rules to the context of the user access attempts.

### BRIEF DESCRIPTION OF SEVERAL VIEWS OF THE DRAWINGS

FIG. 1 illustrates clinical information system incorporating a context manager.

FIG. 2 illustrates a sample of a user interface operating within one embodiment of a context manager.

FIG. 3 illustrates a flow diagram of a method of managing context within a clinical information system.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide systems and methods facilitating sharing of context among a plurality of software applications within a clinical information system. In certain embodiments, control and auditing capabilities are provided for context management of a clinical information system. In certain embodiments a context manager prevents the execution of certain applications, user work tasks or patient data access requests where such events are deemed impermissible by the system, as a precautionary measure to prevent errors in data entry. In certain embodiments a context manager prevents execution of certain components of applications where those components would interfere with applications presently operating, or where the components would not contribute to the task served by the presently operating applications.

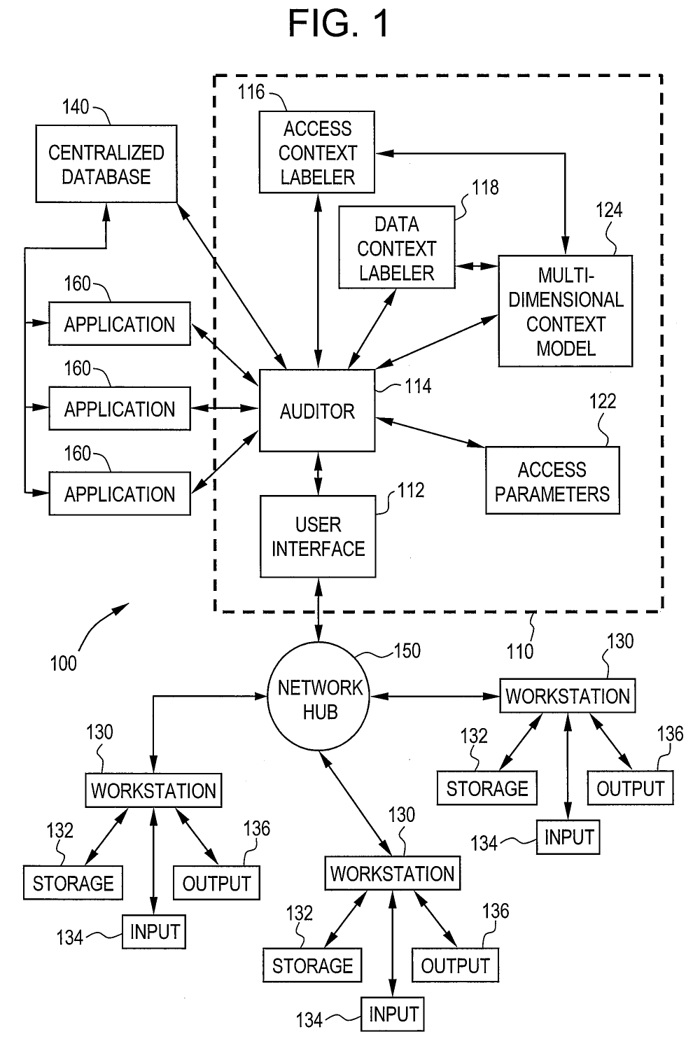

FIG. 1 depicts an embodiment of a clinical information system 100. A centralized database 140 stores patient data and information pertaining to requests to access that patient data. For example, the database may contain information about a patient's visit to a hospital on a particular date, including the medications the patient was prescribed. In addition to this data, the database may also include information including which physician prescribed the medications, when they were prescribed, and which physicians or nurses have made inquiries to each patient data entry.

Data, for example, patient data, is entered into the system 100 through at least one workstation 130, or access point. A workstation 130 may be a computer, or a computer system and will typically comprise at least one input device 134 (e.g., a keyboard, scanner, mouse, etc) as a means of entering data into the workstation, an output device 136 (e.g., a monitor, printer, speakers, etc.) for presenting a display interface to a user, and a storage unit 132. A system 100 may comprise only one workstation 130, though typically, the system 100 will comprise multiple workstations 130, connected to the system 100 and to each other through a network hub 150. The network hub 150 may route information between different components of the system 100, including but not limited to access points, or workstations 130, a centralized database 140, a context manager 110 and various software applications 160.

Workstations 130 serve as access points to the clinical system and allow for users to access patient data within the centralized database 140 through the use of multiple applications 160 or application components operable within the system 100. Examples of applications 160 may include, but is not limited to, email clients, patient billing records programs, patient treatment and diagnosis programs, image recording and viewing applications. It is intended that applications 160, in addition to being the stand-alone applications as referenced above, may also include application components, such as flow sheets, allergies modules, ordering modules, clinical noting tools, triage, specialty clinical forms, and discharge modules, that together with one or more other application components comprise one or more stand-alone applications. Each application (or application component) provides a tool for a workstation 130 to access, review, add, delete or modify data stored within the centralized database 140.

A context manager 110 regulates the context delivered to the centralized database 140 by the applications 160, as well as the context presented to users at the workstations 130. The context manager 110 provides an interface 112 that allows users at workstations 130 to access and operate applications 160. Through the user interface 112 a user may modify, add, delete, view or otherwise access data stored within the centralized database, for example. In certain embodiments the user interface may provide for user operation of multiple applications 160 at a given time. In certain embodiments, the user interface 112 may facilitate the sharing of perspective, environment, or context between multiple applications 160 where applicable, for example.

Several components may constitute the context manager 110. An auditor 114 regulates interaction between applications and between data stored within the centralized database 140. In certain embodiments the auditor 114 may prevent two particular applications from operating concurrently within the same user interface 112, where the relationship between the two applications 160 has been pre-determined to be redundant, illogical or over complicated. In certain embodiments, the auditor 114 may prevent components of applications 160 from interacting with components of other applications 160. For example, a user centric application component, such as a message inbox tool or an overall facility patient list, may not logically interact within a patient context, such as a patient treatment application, thus the auditor may prevent the execution of the applications, or the ability to drill down and access more information in certain situations. In certain embodiments the auditor 114 may also prevent the display of clinical information of multiple patients concurrently to a user to minimize the risk of incorrectly labeling, cross-charting or misdiagnosing patient information, for example.

In certain embodiments, the auditor 114 may prevent certain work tasks or user commands from being executed. For example, the auditor 114 may prevent a user from cutting data from one application (e.g. a patient's prescription information) and pasting it into another application (e.g., the prescription information of another patient), where the command is predetermined to be undesirable across multiple applications. In another embodiment, the auditor 114 may provide limitations that prevent a user from being able to drag and drop, or cut and paste information within a patient encounter to a different encounter for the same patient. For example, the auditor 114 may prevent a user from copying a patient's weight, vital signs, and allergy information recorded during a previous patient visit to an application requesting the same information on a current visit.

In certain embodiments, the auditor 114 references access parameters 122 to regulate context management. For example, an access parameter 122 may define rules preventing the copying of data from a current patient encounter to a previous patient encounter, as this would be clinically incorrect. Additionally, access parameters 122 may define rules that prevent data for a particular patient from being copied to an application that carries context for a different patient, for example. Rules may be defined by access parameters 122 that prevent a user centric application 160 or application component, such as a message inbox tool or overall patient list, from operating among the same user interface as, for example, a patient diagnosis application. In certain embodiments, some parameters 122 may define rules preventing simultaneous display of the clinical information of more than one patient, to minimize the risk of mis-charting or mis-diagnosing a patient, for example.

The auditor 114 applies the access parameters 122 to data based upon a multi-dimensional context model 124 defining the specific context of each data element. Each user request to access patient data is comprised of a series of elements that defines the context of the request, for example, the user identity, that user's duties and authorities, the location of the user, the patient identity, etc. The context model 124 establishes a hierarchical context model that identifies the context of each user command before it is entered. In certain embodiments, a user interface 112 may require a user to “dig down,” or respond to a series of hierarchical queries before accessing patient data.

An example of a hierarchical context model may be defined by seven contextual dimensions, where each dimension is a subsidiary of the context from which it follows, as described in the following embodiments described as follows.

In certain embodiments, the first context dimension may be the physical location context, establishing the location of the system user. For example, a user may be accessing the system from the check-in desk in a hospital emergency room, or from a hospital operating room. The physical context may be broad, defining location as the hospital, the city, state, etc., or the context may be more specific, including information about the actual department, the room or bed number, or the actual computer terminal.

In certain embodiments, a second context dimension may be a logical location, or a declared location context. For example, a doctor practicing at multiple institutions may access the system from a personal office (this would be the doctor's physical location), yet desire to access data from a patient at a first institution, such as a children's hospital (the declared context). The doctor will thus have a physical location context of the personal office, and a declared location context of the children's hospital. In certain embodiments, the declared location may be a subset of the physical location context dimension.

In certain embodiments, the third context dimension may be the user context, defining the user of the system. In the healthcare environment, access to information is tightly regulated. The rights for a particular user logged into the system may determine the level of access to patient data, system resources, or system applications the system and/or user interface should provide. The user context may require a user to enter an access key such as a login name and password to identify the user and demonstrate the authority to access the system. Accordingly, the auditor 114 or application components may be aware of the user logged into the system and thus apply the appropriate system restrictions

In certain embodiments, the fourth context dimension may be the role context, defining the permissions of access to the system for a particular user. Each user may have permission to take on many tasks within a system, but may be prevented from performing other tasks. For example, a clinician may access the system to perform treatment tasks or billing tasks. Even though the clinician may have access to patient clinical data in a treatment roll, access to this data may be prevented when performing the role of a billing clerk to prevent entry of errant or incorrect data. In certain embodiments, role context may be managed as a subset of user context, having implications on the dynamic functionality of the user.

In certain embodiments, the fifth context dimension may be the patient context, identifying the particular patient for which the data accessed is to pertain. When charting clinical observations, creating visit notes, entering diagnostic findings, or administering care in any way, an unambiguous identification of the patient for which the care is directed is crucial in avoiding medical mistakes. Misappropriation of data, medication, or other care to the incorrect patient carries grave consequences. Maintaining and managing a patient context dimension may limit the opportunity for such mistakes.

In certain embodiments, the sixth context dimension may be an encounter context, identifying the particular encounter for the patient with the institution, or the system. Over the course of an individual lifetime, a patient may have several encounters with healthcare facilities and practitioners. Data and notes relevant to care given during one encounter may not apply to another. For example, a particular patient visiting a hospital to birth a child may have a previous encounter with the same hospital for knee surgery. There may, however, be relationships between encounters. For example, a patient's encounter to the emergency department for an acute condition or trauma may be significant with that patient's subsequent follow up care encounters. It may be of significance, to compare the blood pressure measurement during a follow up encounter with that of an initial encounter, for example. Management of encounter relationships may be simplified by maintaining the encounter context for each component managing the data. In certain embodiments, encounter context may be managed as a subset of patient context, having implications on the history of the patient.

In certain embodiments, the seventh and final context dimension may be an application context, identifying the application, and the components of the application, used by the task. In a user interface, such as user interface 112, applications, such as applications 160, may integrate several components, each component focusing around a narrow set of tasks that operate to achieve a unified clinical workflow within the system. Maintaining relevant context limitations for an application allows semantic rules to be placed on component interactions in the presence of the hierarchical clinical context backdrop. For example, some applications, such as a tool for charting vital signs over time, are patient centric, and some, such as a tool for displaying the list of all patients scheduled for a given date at a given clinic, are not patient centric. In certain embodiments, the auditor 114 may prevent use of a patient centric application in a workspace running with no patient context, for example. In certain embodiments, the auditor 114 may limit use of non-patient centric applications to non-patient workspaces for example.

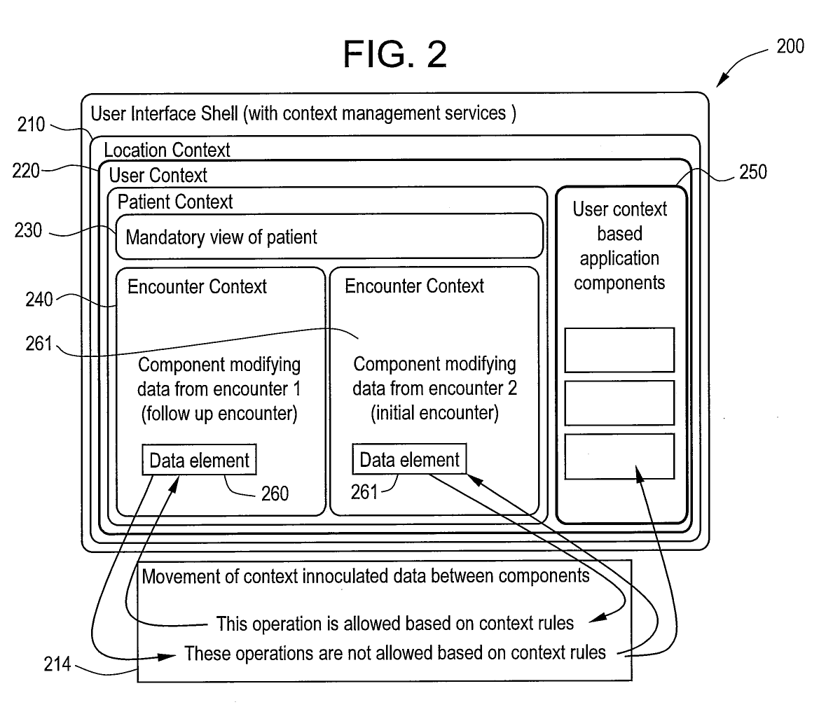

FIG. 2 illustrates a diagram of a user interface shell 200 operating within one embodiment of a context manager The user interface 200 presents a hierarchical status of context to present access to a data element. In the example depicted in the diagram, a user has selected a location context 210, identified a user context 220 as a subsidiary of the location context 210, and is presented with one patient context window 230 and two encounter context windows 240 and 241 as subsidiaries of the user context and the location context 210. Within the encounter context windows 240 and 241, data elements 260 and 261 are presented by the user interface 200.

Within window 230 a user may have the name of an individual patient, for example. The encounter context 240 may represent the patient's previous visit to the hospital, and the encounter context 241 may represent the patient's present visit. Data element 260 may represent the medications prescribed to the patient during the previous visit, and data element 261 may represent the medications to be prescribed during the present visit. The auditor 214 determines whether data element 260 can be applied from the encounter context 240 to encounter context 241 based on the context rules, defined by access parameters, for example. If the rules permit the interaction among the contexts, the user requested task may be performed by the array of applications 250 available in the context. If, on the other hand, the rules do not provide for such a relationship between the encounters, the auditor 214 may prevent the execution of applications or user work tasks.

For example, encounter context 240 may represent a patient's previous visit to a medical clinic in which the patient received a regular checkup, and data element 260 may be the patient's blood pressure on the date of that visit. Encounter context 241 may represent the patient's present visit in which she is being treated for a bacterial infection, and data element 261 defines the measured blood pressure on that visit. In the example embodiment, auditor 214 may allow an application from application array 250 to compare data elements 260 and 261 to diagnose or suggest treatments for the patient. Conversely, the auditor 214 may prevent the user from cutting data element 260 and pasting it in data element 261, if the operation is not allowed based upon the rules. The example embodiment would require collection of the patient's blood pressure during the present visit, and may, for example, not permit further interaction with the interface 200 until such information is provided.

Referring again to FIG. 1, the auditor 114 further interacts with a data context labeler 118 and an access context labeler 116. After the auditor 114 prevents or allows a user to access each element of patient data from the centralized database 140, the access context labeler 116 makes a record of the access attempt, providing a context signature, or a unique identifier to the data based upon the multi-dimensional context model 124. For example, the access context labeler may provide an aggregation of each of the aforementioned context dimensions, providing a vehicle for unique identification and communication of context between components. In certain embodiments, injecting this context signature into components and applications may simplify the system and increase efficiency in the management of clinical data, patient care processes, and clinic organization, for example.

In certain embodiments, the context manager 110 further comprises a data context labeler 118. Similar to the access context labeler 116, the data context labeler provides a context signature or a unique identifier to the actual data that has been accessed, added, or otherwise modified by an application 160. In certain embodiments, the data context signature, along with the access parameters 122 may provide for robust management of the relationships between contexts carried by applications 160 and data elements, or patient data. For example, a patient's height and weight recorded during a general check-up visit may be labeled with a context signature according to the multidimensional context model described above, such that when the height and weight data are accessed at a later date, an auditor 114 may apply access parameters 122 to the context signature to determine whether to allow or prevent future tasks.

In certain embodiments, data collected during a particular patient encounter may be portable to an application component charting a follow-up encounter for previous encounter. In certain embodiments, rules may be defined to prevent copying data from a present encounter to a previous encounter if it would be clinically incorrect. An access parameter rule such as prohibiting the copy of data among between different patients may be applied by an auditor 114 because each data element will have a signature identifying each contextual dimension, for example, the patient name.

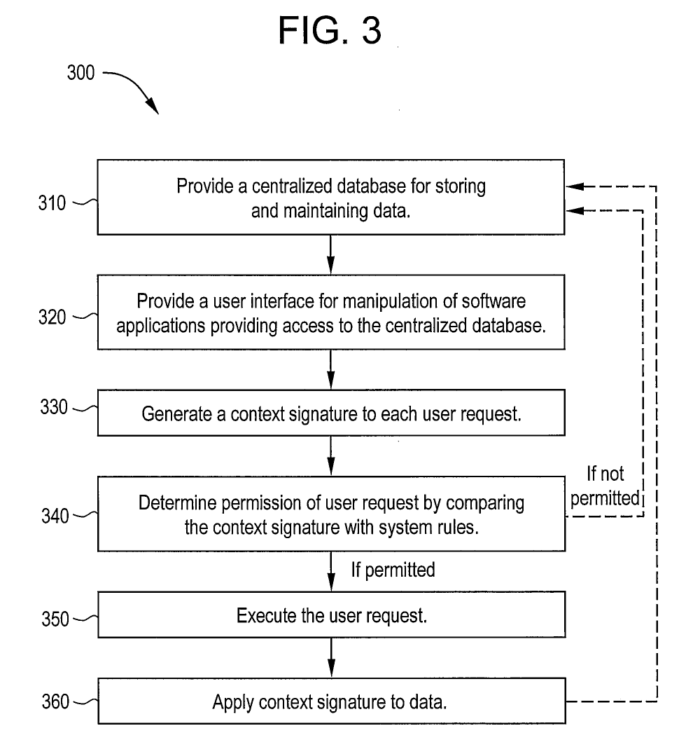

FIG. 3 illustrates a flow diagram of a method 300 for managing context in a clinical information system.

In step 310 a centralized database is provided for storing and maintaining data. In certain embodiments, the data stored in the centralized database may be data relating to the treatment of patients in a clinical facility, or patient data. In certain embodiments, the centralized database maintains information of previous attempts or requests to access data within the database. In certain embodiments the database may be connected to a network of computers or workstations, which may access the database through the use of various software applications.

In step 320 a user interface for manipulation of software applications providing access to the centralized database is provided to a user. In certain embodiments, the user interface is presented via a workstation such as workstation 130 depicted in FIG. 1. In certain embodiments, at step 320 the user interface presents a gateway for interaction with a plurality of software applications that allow for a user to access, add or modify data within the centralized database. For example, the user interface may provide a control screen for accessing a scanning software application, guiding a user through the steps for scanning an image into the centralized database. In step 320 a user may request access to data within a centralized database through at least one software application via a user interface. In certain embodiments, a user may select an icon on the workstation representing the particular application desired for access. In certain embodiments, a user may type in a command or other information into a workstation using a keyboard or other input device. In certain embodiments a user may request access to more than one software application. For example, in step 320 a user may select a link in a user interface representing a patient insurance application in order to gain access to insurance records of a particular patient.

In step 330 a context label, or context signature, is generated and applied to the user request. In certain embodiments, the context signature may contain information pertaining to a hierarchical context model, such as the hierarchical context model 124 described above. In certain embodiments, a user context model may define a context hierarchy, and the signature applied is based upon the context model. In certain embodiments, an auditor, or a context manager applies the context signature to the user request. In certain embodiments, a user interface requires a user to provide the contextual dimensions before the applications may be accessed. In certain embodiments information pertaining to the user request is stored in the centralized database in step 330. For example, the centralized database may store information pertaining to the context signature for each data element requested.

In step 340 the context label is compared with a set of system rules to determine the permissibility, of the access request. In certain embodiments, system rules may be based upon access parameters, such as access parameters 122 as described above. Context rules may be predetermined by a programmer or a system designer depending on the types of interactions between commands, applications and data that are to be prevented. For example, in step 340, an auditor may compare a request to access patient prescription data from a previous encounter within an insurance billing context. In certain embodiments, system rules may be designed to prevent applications from operating concurrently where their concurrent operation is considered to be likely to lead to user confusion, errors in the entry of data, a decrease in system efficiency or other problems, for example. In certain embodiments, system rules may be designed to prevent users from implementing commands, executing tasks, or otherwise modifying patient data where the context of the command is determined to be likely to lead to confusion, errors in data entry, system inefficiency or other problems, for example. In certain embodiments, if the user request is deemed unallowable or impermissible in step 340, the user request is aborted and the method may end or return to step 320 to solicit another user request. If the user request is deemed allowable, the method proceeds to step 350.

In step 350 the user request is executed by the user selected application. For example, a user request to produce the billing records of a particular patient will be displayed on the user interface in step 350.

In step 360 a context label, or a context signature, is applied to the data that was accessed in step 350. For example, in certain embodiments a record is made in the centralized database notifying the physical and declared location context, the user and the role context, the patient and encounter context, and the application context for each data element that has been accessed, added or otherwise modified. After completion of step 360, the method may be completed or returned to step 320 to begin processing another request.

In certain embodiments, advantages are realized in the form of minimized patient risk. For example, by preventing execution of tasks or applications that may be likely to lead to errors during clinical usage, patient and other clinical records are more likely to be maintained accurately. Furthermore, implementation of a system may encourage users to use more care when manipulating the system, so that the tasks requested are not denied.

In certain embodiments, Protected Healthcare Information security may be increased by providing a robust user context under which secure data access and control is applied. In certain embodiments, usability of a clinical information system is improved by the realization of flexibility from customizable user interfaces designed to match clinical workflows. For example, a composite user interface architecture may be manipulated while still permitting robust management and enforcement of hierarchical context based rules.

In certain embodiments, an increase in efficiency of patient care and a decrease in training costs is realized by the implementation of context sensitive clinical workflows. Workflows may dynamically eliminate steps and data that is unnecessary to a specific clinical situation, thereby reducing the time and complexity of practitioner interaction with the system. In certain embodiments, an improvement in the ability to audit transactions is realized by the described technology, thus easing the burden of meeting regulatory and legal requirements within the healthcare domain.

Those skilled in the art will appreciate that the embodiments disclosed herein may be applied to the formation of any clinical system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A system for managing access to patient data in a clinical information system comprising at least two software applications operating to provide access to patent data, and a context manager facilitating sharing of context among said software applications, the system comprising:
at least one access point allowing user interaction with said software applications;
a centralized database storing information relating to patient data and user attempts to access patient data by said software applications;
a first context identification module assigning an identification label to each access attempt based upon context of said access attempt;
a second context identification module assigning an identification label to data gathered by said software applications;
an auditor regulating relationships between said software applications managed by said context manager, said auditor providing a user interface enabling access to said centralized database relating to patient data and attempts to access patient data by said software applications;
wherein, said auditor identifies impermissible application tasks based upon said set of rules and said identification labels, and prevents access to said impermissible application tasks through said user interface.

2. The system of claim 1 wherein said auditor establishes a contextual hierarchy for classifying access attempts and patient data.

3. The system of claim 2 wherein said hierarchy is defined first by a primary contextual dimension and at least one subsidiary contextual dimension.

4. The system of claim 2 wherein said hierarchy is defined first by a physical location context dimension, second by a logical location context dimension, third by a user context dimension, fourth by a role context dimension, fifth by a patient context dimension, sixth by an encounter context dimension, and seventh by an application context dimension.

5. The system of claim 1 further comprising an input wherein a user enters information pertaining to said hierarchy of contextual dimensions.

6. The system of claim 5 wherein a user enters information pertaining to said hierarchy of contextual dimensions by responding to a series of hierarchical queries.

7. The system of claim 1 wherein said auditor references a set of access parameters to regulate relationships between said applications.

8. The system of claim 1 wherein said auditor further regulates execution of user requests entered by user via said user interface.

9. The system of claim 8 wherein said auditor further regulates execution of user requests based upon a set of access parameters.

10. The system of claim 1 further comprising a network hub connecting a plurality of access points with said context manager.

11. A method of managing context shared among at least two software applications within a clinical information system allowing a user to access and modify patient data, said method comprising the steps:
providing a centralized database for storing and maintaining data, said database storing information relating to said patient;
providing a user interface allowing a user to request access to said software applications, said software applications accessing patient data and modifying patient data via user work tasks;
auditing user access to said software applications and said patient data by establishing a multidimensional hierarchical context model for classifying said user requests; establishing system rules identifying allowable and impermissible interaction relationships between said applications, said patient data, and said user requests; acquiring an access context label for each user request for information within said system by applying said multidimensional hierarchical context model to each said user request; acquiring a data context label for each data element accessed or generated by said software applications by applying said multidimensional hierarchical context model to each said data element; and regulating execution of said user requests and access to said software applications and said patient data through said user interface based on said system rules and said access or data context labels.

12. The method of claim 11 wherein said multidimensional context model comprises seven contextual dimensions defined as follows, in hierarchical order: (1) Physical location context dimension defining the actual location of a workstation connected to the system; (2) Logical location context dimension context within which a user desires to interact; (3) User context dimension identifying the user; (4) Role context dimension defining the auditing authority of the user; (5) Patient context dimension identifying the identifying the patient; (6) Encounter context dimension defining the patient encounter with the medical clinic; and (7) Application context identifying the particular application accessed by the user.

13. The method of claim 10 further comprising storing data and information relating to user attempts to access patient data by said software applications within said centralized database.

14. The method of claim 10 further comprising making a record in the centralized database for each data element accessed identifying the contextual dimensions under which said data element has been added, accessed or modified.

15. The method of claim 10 further comprising providing the user with an opportunity to modify an impermissible user request via said user interface.

16. A computer readable medium encoded with instructions for execution in a computer system comprising at least two software applications, a context manager facilitating sharing of context among said software applications, a centralized database accessible to said context manager, an auditor providing an interface enabling a user to extract information from said centralized database relating to patient data and attempts to access said patient data by said software applications, said instructions, when executed on a computer system:
establishing a contextual hierarchy;
establishing application relationship rules governing interaction of said software applications with other software applications, patient data, patient data access requests and user commands;
assigning a context label to each user access attempt based on said contextual hierarchy;
auditing each user task by applying said relationship rules to the context label of each user access attempt,

17. The computer readable medium of claim 16 wherein said instructions, when executed on a computer system further comprise assigning a context label to patient data accessed by said user.

18. The computer readable medium of claim 16 wherein said instructions, when executed on a computer system further comprise establishing a contextual hierarchy defined first by a physical location context dimension, second by a logical location context dimension, third by a user context dimension, fourth by a role context dimension, fifth by a patient context dimension, sixth by an encounter context dimension, and seventh by an application context dimension.

19. The computer readable medium of claim 16 wherein said instructions, when executed on a computer system further comprise auditing each user task by applying said relationship rules to each context label to determine whether user requests to access data on said system are permissible

20. The computer readable medium of claim 18 wherein said instructions, when executed on a computer system further comprise preventing said user requests where said relationship rules dictate that said user request is impermissible based on said context label.
